(19) United States
(12) Patent Application Publication
(10) Pub. No.: US 2013/0299128 A1
(43) Pub. Date: Nov. 14, 2013

(54) AIR-CONDITIONED SEAT FOR A CABIN OF A VEHICLE

(71) Applicant: Dimitri Bergamini, Portomaggiore (IT)

(72) Inventor: Dimitri Bergamini, Portomaggiore (IT)

(21) Appl. No.: 13/882,121

(22) PCT Filed: Oct. 28, 2011
(86) PCT No.: PCT/IB11/02550

§ 371 Date: Jul. 19, 2013

Related U.S. Application Data
(60) Provisional application No. 61/420,455, filed on Dec. 7, 2010.

(30) Foreign Application Priority Data
Oct. 28, 2010 (IT) BO2010A000651

(51) Int. Cl. B60N 2/56

(52) U.S. Cl. CPC B60N 2/56
USPC 165/59; 62/259.3

(57) ABSTRACT

A seat for a cabin of a vehicle, presenting breathable seating and backrest portions (7, 8). The seat (1) has a shell (11), which is rigidly coupled to the rear side (4al) of the backrest (4) and presents an air intake (15) and air vents (12a-12d) for the cabin, and an air-conditioning unit (16), which is housed in the shell (11) and has a coolant inlet (21), an expansion valve (22) connected to the coolant inlet (21), an evaporator (23) connected to the expansion valve (22) for cooling the air sucked in, a coolant outlet (24) connected to the expansion valve (22) and an electric fan (25). In the shell (11) and in the base (2) of the seat (1) there are air distribution chambers (18, 32) communicating with the outlet (19) of the air-conditioning unit (16), the air vents (12a-12d) and the breathable seating and backrest part portions (7, 8).

### TECHNICAL FIELD

The present invention relates to an air-conditioned seat for a cabin of a vehicle.

In particular, the present invention is advantageously, but not exclusively, intended for use in medium and small-sized cabins typical of work vehicles such as, for example, tractors, mini-excavators, crane trucks, telescopic handlers, skid steer loaders, etc., to which the following description specifically refers but without any loss of generality.

### BACKGROUND ART

The most modern cabins for the types of vehicles listed above are hermetically sealed and air-conditioned for improved comfort of the operator sitting inside the cabin. Such vehicles are normally provided with a conventional air-conditioning system comprising a compressor, a condenser, an expansion valve and an evaporator connected in series and in that order by means of ducts through which a coolant flows to form a coolant refrigeration circuit. The compressor is normally driven by the engine of the vehicle. The evaporator is coupled to a fan to produce a flow of cold air that is directed towards air vents arranged on the instrument panel in the cabin. The air-conditioning system also comprises a heater fed with hot fluid, for example the water from the engine cooling system, to heat the air delivered to the air vents. The cooling cycle and the heater are appropriately controlled and the ducts feeding the air vents are specifically designed to enable the cold air to be mixed with the warm air. The air-conditioning system is housed in the engine compartment of the vehicle.

However, this kind of air-conditioning system is often not sufficient to guarantee the well-being of the operator in view of the extreme environmental conditions in which the vehicle is used, and particularly during hot weather due to the huge amount of heat generated by the powerful engine with which such vehicles are normally equipped. The result is that the parts of the operator's body that come into contact with the seat, which is often very basic for obvious reasons of simplicity and convenience, are never at comfortable temperature or humidity levels. In other words, despite the presence of the air-conditioning system, the operator feels cold in winter and hot in summer.

Solutions for air-conditioning the driver's or passenger's seat are known in the automobile sector. Some of these solutions involve complex systems for distributing the conditioned air, which draw in conditioned air from the vehicle's air-conditioning system and distribute this to breathable seating and backrest portions of the seat. Another solution, described for example in patent application US 2007/0193279, consists of two small air-conditioning units using Peltier modules arranged respectively in the seating portion and backrest portion of the seat.

The solutions described above for an air-conditioned seat are, however, not suitable for the cabin of a vehicle, in that they are too complex, and thus expensive and not robust, nor do they provide adequate air-conditioning for the extreme environmental conditions in which the vehicle is normally used.

### DISCLOSURE OF INVENTION

The purpose of the present invention is to provide an air-conditioned seat and relative air-conditioning system for the cabin of a vehicle, which overcome the drawbacks described above and, at the same time, are easy and economical to produce.

According to the present invention there are provided a seat for the cabin of a vehicle and an air-conditioning system for a cabin of a vehicle, as set forth in the appended claims.

### BRIEF DESCRIPTION OF THE DRAWINGS

The present invention will now be described with reference to the accompanying drawings, illustrating a non-limiting embodiment thereof, in which:

FIG. 1 is a perspective view from the front of the air-conditioned seat according to the present invention;

FIG. 2 is a perspective view from the rear of the seat of FIG. 1;

FIG. 3 is a simplified cross-sectional view of the inside of the seat of FIG. 1; and

FIG. 4 is the block diagram of the air-conditioning system according to the invention.

### BEST MODE FOR CARRYING OUT THE INVENTION

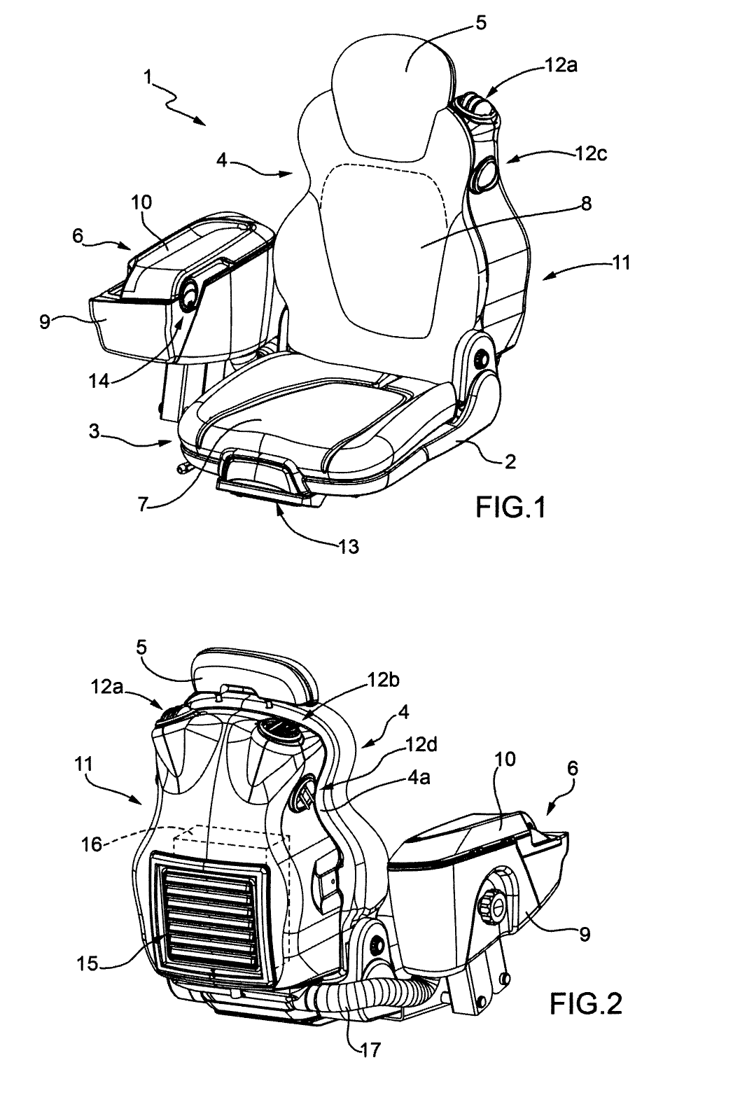

In FIG. 1, number 1 generally indicates, as a whole, the air-conditioned seat according to the invention and which can be installed in the cabin of a vehicle. The seat 1 comprises a base 2, a seating part 3 mounted on the base 2 and a backrest part 4 hinged to the base 2. The backrest part 4 is provided with a headrest 5. Moreover, the seat comprises a lateral armrest 6 anchored to the base 2. The seating part 3 and the backrest part 4 comprise respective breathable portions 7 and 8, hereinafter, for the sake of simplicity, referred to as breathable seating part portion 7 and breathable backrest part portion 8, which, in use, come into contact with the relative parts of the driver's body (not illustrated). The armrest 6 comprises a substantially hollow element 9 that is open at the top and a cover 10 hinged to the element 9 to close the latter.

The seat 1 comprises a shell 11 that is rigidly coupled to the rear side 4a (FIG. 2) of the backrest part 4 and provided with one or more air vents 12a-12d directed or rotatable towards the upper part of the vehicle cabin. FIG. 1 shows an air vent 12a arranged in an upper portion of the shell 11 behind the headrest 5 and facing upwards and an air vent 12c arranged in a left side portion of the shell 11. The base 2 is provided with an air vent 13 directed or rotatable towards the driver's feet. The armrest 6 is provided with a further air vent 14 arranged on a side wall of the element 9 and directed or rotatable towards those parts of the driver's body that, when the latter is sitting on the seat 1, do not come into contact with the seating part 3 and the backrest part 4.

With reference to FIG. 2, which shows the two air vents 12a and 12b on the upper portion of the shell 11, an air vent 12d is arranged in a right lateral portion of the shell 11 and an air intake 15 is obtained in a central rear portion of the shell 11. The seat 1 comprises a single heating, ventilation and air-conditioning unit (HVAC), hereinafter simply referred to as a ventilation and air-conditioning unit and indicated by number 16, which is housed in the shell 11 so as to suck air from the air intake 15 and produce a flow of conditioned air to feed to the various air vents and to the breathable portions of the seating part 3 and backrest part 4. A duct 17 leads from a lower portion of the shell 11 to a lower portion of the element 9 of the armrest 6 to feed conditioned air to the air vent 14 (FIG. 1) of the armrest 6.

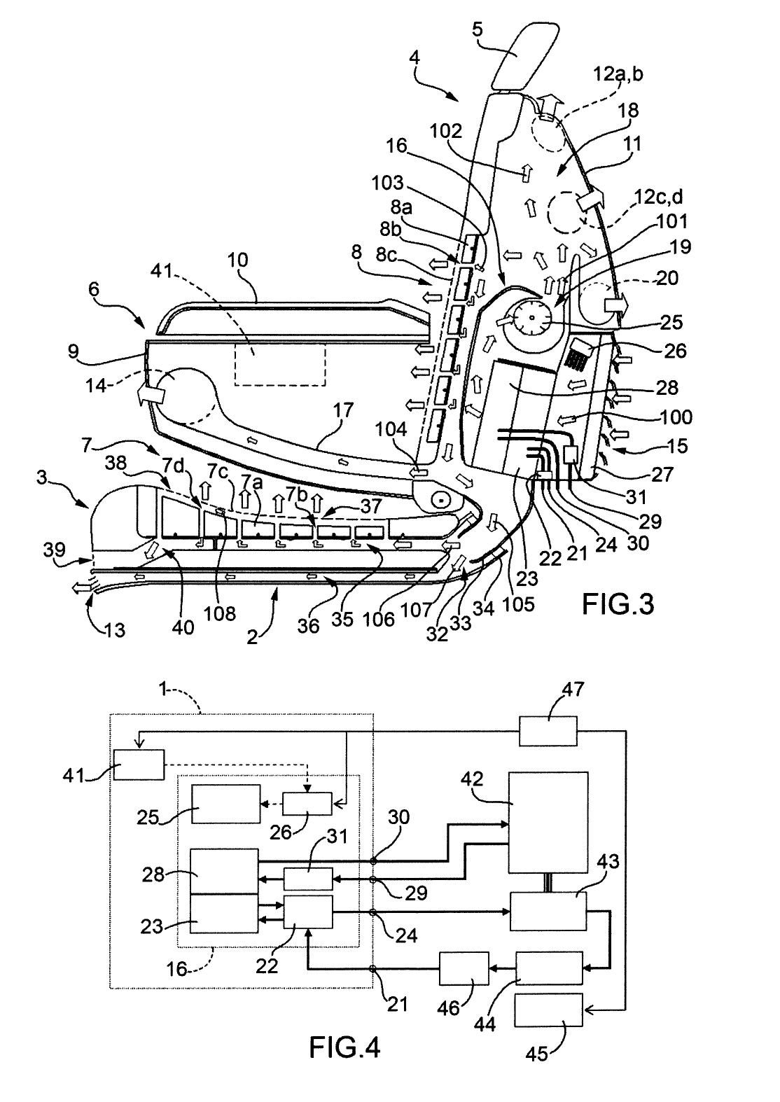

With reference to FIG. 3, which is a simplified cross-sectional view of the inside of the seat 1, the seat 1 comprises a first air distribution chamber 18, which is housed in the shell 11 and communicates with the outlet 19 of the ventilation and air-conditioning unit 16 to receive from the latter the flow of conditioned air and with the air vents 12a-12d and the breathable backrest part portion 8 to distribute at least part of said flow of conditioned air to the air vents 12a-12d and to the breathable backrest part portion 8. The duct 17 connects the air distribution chamber 18 with the air vent 14 of the armrest 6, so as to feed a portion of the conditioned air flow to the air vent 14. The distribution chamber 18 preferably, but not necessarily, communicates with a defrost outlet 20 suitable to be connected to the window ventilation system (not illustrated) of the vehicle cabin to defrost said windows. The defrost outlet 20 is illustrated in the upper part of the distribution chamber 18, that is in the upper part of the shell 11, but it may be arranged in any other part of the distribution chamber 18.

In FIG. 3, the air flowing into the air intake 15, in the various parts of the seat 1, and flowing out of the air vents and the breathable portions of the seat 1, are represented by several white arrows outlined in black. For example, the arrows labelled 100 represent the air sucked in through the air intake 15, the arrows labelled 101 represent the flow of conditioned air delivered to the outlet 19 of the ventilation and air-conditioning unit 16 and fed into the distribution chamber 18, the arrows labelled 102 represent a portion of the flow of conditioned air 100 fed to the air vents 12 and 12b, the arrows labelled 103 represent a portion of the flow of conditioned air 100 fed to the breathable backrest part portion 8 and the arrows labelled 104 represent a portion of the flow of conditioned air 100 fed to the air vent 14.

The ventilation and air-conditioning unit 16 comprises a coolant inlet 21, an expansion valve 22 consisting, in particular, of a four-way expansion valve connected to the coolant inlet 21, an evaporator 23 connected in parallel to the expansion valve 22 for cooling the air sucked in by the air intake 15, a coolant outlet 24 connected to the expansion valve 22, an electric fan 25 for producing the flow of conditioned air at the outlet 19 of the ventilation and air-conditioning unit 16, and a speed regulator 26 consisting of a voltage regulator to control the electric fan 25. An air filter 27 is arranged behind the air intake 15.

According to a further embodiment of the invention that is not illustrated, the ventilation and air-conditioning unit 16 comprises, in place of the expansion valve 22, a two-way expansion valve, which is connected between the coolant inlet 21 and the evaporator inlet 23, and has the coolant outlet 24 connected directly to the evaporator outlet 23.

Again with reference to FIG. 3, the ventilation and air-conditioning unit 16 comprises a heater 28 coupled to the evaporator 23 for heating the air that is sucked in. The heater 28 is of the type which can be fed with hot fluid, for example hot water or oil supplied by the cooling system of an internal combustion engine. The ventilation and air-conditioning unit 16 comprises a hot fluid inlet 29, a hot fluid outlet 30 and a control valve 31, which is connected in series to the heater 28 between the hot fluid inlet 29 and the hot fluid outlet 30 to control the flow rate of the hot fluid in the heater 28. With respect to the circulation direction of the air through the evaporator 22, that is, with respect to the circulation direction of the air sucked in 100, the heater 28 is arranged downstream of the evaporator 22 and the electric fan 25 is arranged downstream of the heater 28.

According to a further embodiment of the invention that is not illustrated, the ventilation and air-conditioning unit 16 comprises an electric heater in place of the hot fluid heater 28.

Again with reference to FIG. 3, the breathable seating part portion 8 comprises a layer of polyurethane foam padding 8a, in which small holes 8b have been obtained through which the air can flow, and an open mesh fabric cover 8c, which covers the outer side of the layer of padding 8a and thus defines the surface which, when in use, comes into contact with the driver's body. The air distribution chamber 18 communicates with the inner side of the layer of padding 8a, that is directly with the holes 8b. Thus, the portion of the flow of air 103 leaves the breathable backrest part portion 8 through the holes 8b and the cover 8c.

The seat 1 also comprises a second air distribution chamber 32, which is arranged in the base 2 of the seat 1 and communicates with the air distribution chamber 18 to receive, from the latter, a portion 105 of the flow of conditioned air 100 and with the breathable seating part portion 7 and with the air vent 13 in the base 2 to distribute the portion of the flow of air 105 to the breathable seating part portion 7 and to the air vent 13. The air distribution chamber 18 comprises an air vent 33 that protrudes from the lower part of the shell 11 and the air distribution chamber 32 comprises an air inlet 34 which protrudes from the rear side of the base 2 of the seat 1 and is hermetically coupled to the air inlet 33. The air distribution chamber 32 is double, and in particular it forks from the air inlet 34 into a distribution chamber 35, which communicates with the inner side of the breathable seating part portion 7, and into an air distribution chamber 36, which is arranged beneath the distribution chamber 35 and communicates with the air vent 13. The breathable seating part portion 7 has substantially the same structure and the same function as the breathable backrest part portion 8, that is, it comprises a layer of polyurethane foam padding 7a, holes 7b obtained in the layer of padding 7a and an open mesh fabric cover 7c covering the outer side of the layer of padding 7a. The distribution chamber 35 thus communicates directly with the holes 7b. The portion of the flow of air 105 is thus split into a portion of the flow of air 16, which flows through the distribution chamber 35 and out of the breathable seating part portion 7 through the holes 7b and the cover 7c, and a portion of the flow of air 107, which flows through the distribution chamber 36 and out of the air vent 13.

Advantageously, the breathable seating part portion 7 is divided, in the circulation direction of the portion of the flow of air 106, into a first breathable portion 37 and a second breathable portion 37, which is smaller than the first breathable portion 37 and is arranged in the front part of the seating part 3. The double air distribution chamber 32, and in particular the distribution chamber 35, communicates with the breathable portion 37. The base 2 of the seat 1 comprises a discharge opening 39 and a discharge chamber 40, which is separated from the distribution chamber 35 and connects the breathable portion 38 with the discharge opening 39. The breathable portion 37 comprises the holes 7b and the breathable portion 38 comprises other holes 7d, the latter communicating with the discharge chamber 40. In use, the part of conditioned air that is fed to the breathable portion 37 but does not flow out from the breathable seating part portion 7 due to the presence of the body of the driver sitting on the seat 1, flows along the breathable seating part portion 7, between the layer of padding 7a and the cover 7c, and is discharged outside the seating part 3 through the breathable portion 38, that is, it is sucked in by the discharge chamber 40 through the holes 7d of the breathable portion 38 and then discharged through the discharge opening 39. The flow of air circulating along the breathable seating part portion 7 is represented by the arrow 108. Thus, the air is prevented from stagnating in the breathable seating part portion 7 and facilitates the dehumidification of the seating part 3.

The element 9 of the armrest 6 houses 10 a control panel 41 to control the operation of the ventilation and air-conditioning unit 16, and in particular to regulate the control valve 31 so as to regulate the temperature of the flow of conditioned air 101 and to regulate the speed control valve 26 so as to regulate the flow rate of the conditioned air 101. The control panel 41 is arranged with the relative knobs and buttons near to the opening of the element 9 so as to be immediately accessible by the driver after raising the cover 10. Optionally, the element 9 of the armrest 6 comprises a compartment (not illustrated) for bottles of beverages, said compartment being accessible through the cover 10 and cooled by conditioned air fed via the duct 17.

With reference to FIG. 4, the vehicle, in the cabin of which the seat 1 is installed, comprises an internal combustion engine 42 and an air-conditioning system, which comprises a compressor 43 driven by the internal combustion engine 42 to compress a coolant, a condenser 44 connected to the compressor outlet 43, an electric fan 45 coupled to the condenser 44 and a drier filter 46 connected to the condenser outlet 44. The ventilation and air-conditioning unit 16 of the seat 1 has the coolant inlet 21 connected downstream of the condenser 44 and, in particular to the outlet of the drier filter 46, and the coolant outlet 24 connected to the compressor inlet 43. Thus, the ventilation and air-conditioning unit 16, with the compressor 43, the condenser 44 and the drier filter 46, constitutes a respective cooling circuit. Moreover, the hot fluid inlet 29 and the hot fluid outlet 30 are connected to the cooling circuit of the internal combustion engine 42. The battery 47 of the vehicle delivers electrical power to the speed control 26 and the control panel 41.

Thus, the seat 1 is part of the vehicle's air-conditioning system, in which the compressor 43, condenser 44 and drier filter 46 are arranged, for example, in the engine compartment of the vehicle, while the expansion valve 22, evaporator 23 and air vents 12a-12d, 13, 14 are arranged on-board the seat 1.

The main advantage of the air-conditioned seat 1 described above is that it can be installed in the cabin of any vehicle and easily integrated into the vehicle's existing air-conditioning system to implement a new air-conditioning system that improves the overall well-being of the driver.

The air-conditioned seat 1 according to the present invention integrates in a single object: a ventilated seat, that is, with a seating part 3 and a backrest part 4 provided with respective breathable portions 7 and 8 for ventilating the driver's body; air vents 12, 13, 14 for conditioning the air in the entire cabin of the vehicle, that is, to air-condition and ventilate the upper part of the cabin, the lower part of the cabin (footwell) and the central part of the cabin (parts of the driver's body that are not in contact with the seating part 3 and the backrest part 4); a single ventilation and air-conditioning unit 16 to feed a flow of conditioned air (cooled and/or heated) for distribution to the various air vents and to the ventilated seat; and a control panel 41 incorporated in the armrest 6 of the seat 1 to control the operation of the ventilation and air-conditioning unit 16.

In particular, it makes designing an air-conditioning system for the cabin of a vehicle quicker and cheaper, in that the seat 1 is suitable for the cabin of any vehicle that is simply provided with a compressor and a condenser for cooling a coolant and thus the vehicle manufacturer does not need to design the other components required for an air-conditioning system, such as the evaporator, heater, electric fan, air vents and control panel. Moreover, the air-conditioned seat 1 according to the invention can be installed in the cabin easily and quickly, in that it is sufficient to connect the inlets 21 and 29 to the condenser and to the compressor, the outlets 24 and 30 to the cooling system of the engine of the vehicle, and the electrical parts directly to the battery of the vehicle, and it is immediately ready for use as soon as it has been installed (plug & play).

The air-conditioned seat 1 according to the invention also allows vehicle manufacturers to streamline their spare parts logistics chain. Last, but not least, with the air-conditioned seat 1 according to the invention, the weight and overall dimensions of the vehicle's air-conditioning system are reduced, with an effect on the vehicle's autonomy that is not negligible, and the energy efficiency of the air-conditioning system in the cabin is improved.

1. Seat for a cabin of a vehicle, comprising: a breathable backrest portion (8), which, when in use, comes into contact with the body of the driver; a shell (11), which is rigidly coupled to the rear side (4a) of the backrest (4) and presents at least one air intake (15) and at least one first air vent (12a-12d) for the cabin; a single ventilation and air-conditioning unit (16), which is housed in the shell (11), so as to suck air (100) from the air intake (15), and comprises a coolant inlet (21), an expansion valve (22) connected to the coolant inlet (21), an evaporator (23) connected to the expansion valve (22) for cooling said air sucked in (100), a coolant outlet (24) connected to the evaporator (23) or to the expansion valve (22) and ventilator means (25) for producing a flow of conditioned air (101) at the outlet (19) of the ventilation and air-conditioning unit (16); and a first air distribution chamber (18), which is housed in the shell (11) and communicates on the one end with the outlet (19) of the ventilation and air-conditioning unit (16), so as to receive, from the latter, said flow of conditioned air (101), and on the other hand with said first air vent (12a-12d) and said breathable backrest portion (8) for distributing at least part of said flow of conditioned air (101) to the first air vent (12a-12d) and the breathable backrest portion (8).

2. Seat according to claim 1, wherein said ventilator means (25) are arranged downstream of said evaporator (23) with respect to the circulation direction of air (100) through the evaporator (23).

3. Seat according to claim 1, wherein said ventilation and air-conditioning unit (16) comprises a heater (28), which is coupled to said evaporator (23), for heating said air sucked in (100).

4. Seat according to claim 3, wherein said heater (28) is arranged downstream of said evaporator (23) with respect to the circulation direction of air (100) through the evaporator (23).

5. Seat according to claim 3, wherein said heater (28) is of the type which can be fed with hot fluid; said ventilation and air-conditioning unit (16) comprising a hot fluid inlet (29), a hot fluid outlet (30) and a control valve (31), which is connected in series to the heater (28) between the hot fluid inlet (29) and the hot fluid outlet (30).

6. Seat according to claim 1, and comprising a breathable seating part portion (7), which, when in use, comes into contact with the body of the driver, and a second air distribution chamber (32), which is arranged in the base (2) of the seat (1) and communicates with said first air distribution chamber (18), so as to receive, from the latter, a portion (105) of said flow of conditioned air (101), and with the breathable seating part portion (7) for distributing at least part of said portion (105) of said flow of conditioned air (101) to said breathable seating part portion (7).

7. Seat according to claim 6, wherein said base (2) of the seat (1) presents a second air vent (13) for the feet of the driver; said second air distribution chamber (32) communicating with the second air vent (13) for distributing at least part of said portion (105) of said flow of conditioned air (101) to said second air vent (13).

8. Seat according to claim 7, wherein said first air distribution chamber (18) comprises an air outlet (33) which protrudes from the lower part of said shell (11) and said second air distribution chamber (32) comprises an air inlet (34) which protrudes from the rear side of the base (2) of the seat (1) and is coupled to said air outlet (33); said second air distribution chamber (32) forking from said air inlet (34) into a third distribution chamber (35), which communicates with said breathable seating part portion (7), and into a fourth distribution chamber (36), which communicates with said second air vent (13).

9. Seat according to claim 6, wherein said breathable seating part portion (7) is divided, following the circulation direction of the air (106) in said second air distribution chamber (32), into a first breathable portion (37) and a second breathable portion (38); said second air distribution chamber (32) communicating with said first breathable portion (37), so as to feed conditioned air to the latter; said base (2) of the seat (1) comprising a discharge opening (39) communicating with said second breathable portion (38), so that the part of conditioned air (108) which, when in use, is fed to said first breathable portion (37) but cannot get out of the breathable seating part portion (7) due to the presence of the body of the driver, flows along the breathable seating part portion (7) and is discharged outside the seating part (3) through the second breathable portion (38) and the discharge opening (39), in order to favour the dehumidification of the seating part (3).

10. Seat according to claim 1, and comprising a lateral armrest (6), which presents a third air vent (14) and incorporates a control panel (41) for controlling the operation of said ventilation and air-conditioning unit (16), and a duct (17) for putting into communication said first air distribution chamber (18) with the third air vent (14).

11. Air-conditioning system for a cabin of a vehicle, the air-conditioning system comprising a compressor (43) for compressing a coolant and a condenser (44) connected downstream of the compressor (43); the air-conditioning system being characterised in that it comprises the seat (1) claimed in claim 1; said coolant inlet (21) being connected downstream of the condenser (44) and said coolant outlet (24) being connected to the inlet of the compressor (43).
